(19) United States
(12) Patent Application Publication
(10) Pub. No.: US 2026/0276143 A1
(43) Pub. Date: Sep. 17, 2026

(54) GREASE GUN INCLUDING CANISTER LEVEL SENSING

(71) Applicant: MILWAUKEE ELECTRIC TOOL CORPORATION, Brookfield, WI (US)

(72) Inventors: Muntather M. Alnasser, Sussex, WI (US); Jacob R. McDonald, Ixonia, WI (US); Samuel J. Becker, Wauwatosa, WI (US); Wesley S. Bassindale, Wauwatosa, WI (US); Arber Halimi, Hartland, WI (US); Alejandro M. Damonte Vegas, Menomonee Falls, WI (US); Suresh Natesan, Menomonee Falls, WI (US); Michael R. Rohrer, Milwaukee, WI (US)

(21) Appl. No.: 19/566,396

(22) Filed: Mar. 13, 2026

Related U.S. Application Data
(60) Provisional application No. 63/771,816, filed on Mar. 14, 2025.
(60) Provisional application No. 63/900,784, filed on Oct. 17, 2025.

(51) Int. Cl. F16N 3/12

(52) U.S. Cl. CPC F16N 3/12; F16N 2250/18

(57) ABSTRACT

A grease gun includes a housing that supports a motor assembly, a pump assembly driven by the motor assembly to generate a flow of grease, and a plunger. A grease gun may include a canister assembly configured to provide grease to the pump assembly, the canister assembly including a canister defining an interior in which grease is stored and a piston that is translatable within the canister along a canister axis. A grease gun also includes a pump housing supported by the housing and to which the canister assembly is coupled, the pump housing defining a discharge path in which the plunger is at least partially supported, the discharge path communicating the interior of the canister with an outlet of the discharge path, and a sensor configured to monitor a position of the piston and output a signal indicative of the position of the piston.

### CROSS-REFERENCE TO RELATED APPLICATIONS

This application claims priority to co-pending U.S. Provisional Patent Application No. 63/771,816, filed on Mar. 14, 2025, and to U.S. Provisional Patent Application No. 63/900,784, filed on Oct. 17, 2025, the entire contents of each of which are incorporated herein by reference.

### FIELD

The present disclosure relates to a grease gun and, more particularly, to a grease gun including grease canister level sensing.

### BACKGROUND

Grease guns distribute grease from a canister, typically through a hose, to a grease fitting coupled to an external assembly that requires regular replenishment of grease to continue smooth operation. In a grease gun, especially a grease gun having an opaque canister, it is difficult to determine the volume of grease remaining in the canister.

### SUMMARY

The present disclosure provides, in one aspect, a grease gun configured to dispense grease including: a housing; a motor assembly supported in the housing; a pump assembly driven by the motor assembly to generate a flow of grease, the pump assembly including a plunger; a canister assembly configured to provide grease to the pump assembly, the canister assembly including a canister defining an interior in which grease is stored and a piston that is translatable within the canister along a canister axis; a pump housing supported by the housing and to which the canister assembly is coupled, the pump housing defining a discharge path in which the plunger is at least partially supported, the discharge path communicating the interior of the canister with an outlet of the discharge path; and a sensor configured to monitor a position of the piston and output a signal indicative of the position of the piston.

The present disclosure provides, in another aspect, a grease gun configured to dispense grease including: a housing; a motor assembly supported in the housing; a pump assembly driven by the motor assembly to generate a flow of grease, the pump assembly including a plunger; a canister assembly configured to provide grease to the pump assembly, the canister assembly including a canister defining an interior in which grease is stored and a piston that is translatable within the canister along a canister axis; a pump housing supported by the housing and to which the canister assembly is coupled, the pump housing defining a discharge path in which the plunger is at least partially supported, the discharge path communicating the interior of the canister with an outlet of the discharge path; a sensor target coupled to and movable with the piston; and a sensor configured to monitor a position of the sensor target and output a signal indicative of the position of the sensor target and the piston.

The present disclosure provides, in another aspect, a grease gun configured to dispense grease including: a housing; a motor assembly supported in the housing; a pump assembly driven by the motor assembly to generate a flow of grease, the pump assembly including a plunger; a canister assembly configured to provide grease to the pump assembly, the canister assembly including a canister defining an interior in which grease is stored and a piston that is translatable within the canister along a canister axis; a pump housing supported by the housing and to which the canister assembly is coupled, the pump housing defining a discharge path in which the plunger is at least partially supported, the discharge path communicating the interior of the canister with an outlet of the discharge path; a magnet having a ring shape coupled to a shuttle that is coupled to and movable with the piston; and a Hall effect sensor configured to monitor a position of the magnet and output a signal indicative of the position of the magnet and the piston.

Other features and aspects of the subject matter will become apparent by consideration of the following detailed description and accompanying drawings.

### BRIEF DESCRIPTION OF THE DRAWINGS

FIG. 1 is a cross-sectional view of a grease gun.

FIG. 2 is a cross-sectional view of another embodiment of a grease gun.

FIG. 3 is an enlarged, cross-sectional view of the grease gun of FIG. 2, illustrating a piston.

FIG. 4 is a front, section view of a portion of a grease gun, including a canister, sensor board, and an embodiment of a piston including magnets.

FIG. 5 is a front, section view of a portion of a grease gun, including a canister, sensor board, and a magnetic orientation.

FIG. 6 is a front, section view of a portion of a grease gun, including a canister, sensor board, and a magnetic orientation.

FIG. 7 is a cross-sectional view of a portion of the grease gun of FIG. 1.

FIG. 8 is a cross-sectional view of another embodiment of a grease gun, including a magnet orientation.

FIG. 8A is an end view of a magnet arrangement for use with the grease gun of FIG. 8

FIG. 8B is a top view of a magnet arrangement for use with the grease gun of FIG. 8

FIG. 9A is an end view of another magnet arrangement for use with the grease gun of FIG. 8.

FIG. 9B is a top view of the magnet arrangement of FIG. 9A, for use with the grease gun of FIG. 8.

FIG. 9C is a schematic representation of the poles of the magnet arrangement of FIG. 9A.

FIG. 10A is an end view of another magnet arrangement for use with the grease gun of FIG. 8.

FIG. 10B is a top view of the magnet arrangement of FIG. 10A, for use with the grease gun of FIG. 8.

FIG. 10C is a schematic representation of the poles of the magnet arrangement of FIG. 10A.

FIG. 11A is a top view of another magnet arrangement for use with the grease gun of FIG. 8.

FIG. 11B is a schematic representation of the poles of the magnet arrangement of FIG. 11A.

FIG. 12 is a perspective view of another embodiment of a grease gun.

FIG. 13 is a cross-sectional view of a portion of the grease gun of FIG. 12.

FIG. 14 is a top view of an embodiment of an indicator of the grease gun of FIG. 12.

FIG. 15 is a top view of another embodiment of a portion of an indicator configured to be used with grease gun of FIG. 12.

FIG. 16 is a schematic diagram of a sensor to be used with the grease gun of FIG. 12.

FIG. 17 is a schematic diagram showing positions of a sensor target relative to the sensor of FIG. 16.

FIG. 18 is a graph of the position of a sensor target relative to a sensor and the resulting sensor outputs.

Before any embodiments of the subject matter are explained in detail, it is to be understood that the disclosure is not limited in its application to the details of construction and the arrangement of components set forth in the following description or illustrated in the following drawings. The subject matter is capable of other embodiments and of being practiced or of being carried out in various ways. Also, it is to be understood that the phraseology and terminology used herein is for the purpose of description and should not be regarded as limiting.

Terms of approximation, such as “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

### DETAILED DESCRIPTION

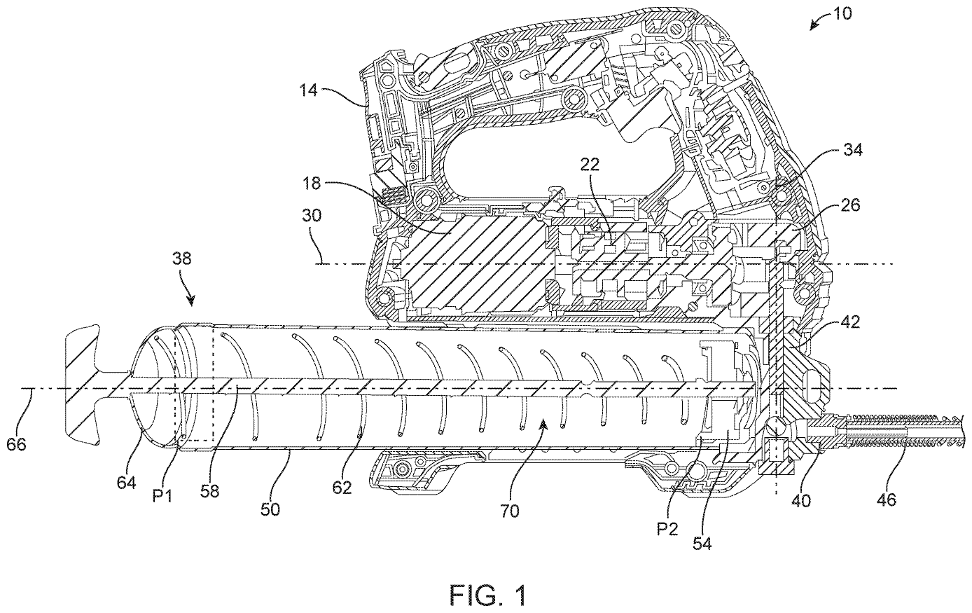

FIG. 1 illustrates a grease gun 10 including a housing 14 that supports a motor assembly 18, a gear assembly 22, and a pump assembly 26. The motor assembly 18 may include, for example, a brushless DC motor. In other embodiments, the motor assembly 18 may include other types of motors, such as a brushed motor or an AC motor. The motor assembly 18 provides a rotational output about a rotation axis 30 to the gear assembly 22, which in turn provides a rotational output about the rotation axis 30 to the pump assembly 26. The gear assembly 22 may include, for example, a planetary gear assembly. In some embodiments, the planetary gear assembly may include multiple stages. In the illustrated embodiment, the planetary gear assembly includes four stages. The gear assembly 22 may be operable at multiple speeds. In the illustrated embodiment, the gear assembly 22 may be operable at two speeds. In other embodiments, the gear assembly 22 may include other components and/or configurations. The pump assembly 26 reciprocates along a pump axis 34 in response to the rotational output from the gear assembly 22. Reciprocation of the pump assembly 26 dispenses grease from a canister assembly 38 coupled to a pump housing 42. The pump housing 42 is supported by the housing 14. In some embodiments, the pump housing 42 may be supported at least partially within the housing 14. The grease is dispensed from the pump housing 42 to a hose 46 that is coupled to an outlet 40 of the pump housing 42.

The canister assembly 38 includes a canister 50 (e.g., an aluminum canister) that is couplable to the pump housing 42 (e.g., by threaded connection, a bayonet-style connection, or the like). The canister assembly 38 also includes a piston 54 (e.g., a rubber piston) and rod 58 movably (e.g., slidably) supported in the canister 50. A spring 62 engaging a distal end 64 of the canister 50 biases the piston 54 and rod 58 from a first position P1 along a canister axis 66 toward a second position P2 adjacent the pump housing 42 to expel the grease stored in the canister 50 to the pump assembly 26. In the illustrated embodiment, the spring 62 is a coil compression spring. In other embodiments, the canister assembly 38 may include other suitable springs. The canister 50 and the piston 54 define an interior 70 having a variable volume depending on the position of the piston 54 in the canister 50 relative to the pump housing 42. The variable volume is a maximum volume when the piston 54 is at the first position P1. The variable volume is a minimum volume when the piston 54 is at the second position P2, corresponding to the canister 50 being emptied (or nearly emptied) of grease. As the pump assembly 26 pumps grease from the canister 50, the piston 54 and rod 58 translate within the canister 50 under the force applied by the spring 62 to urge the remaining grease in the canister 50 toward the pump housing 42 and pump assembly 26.

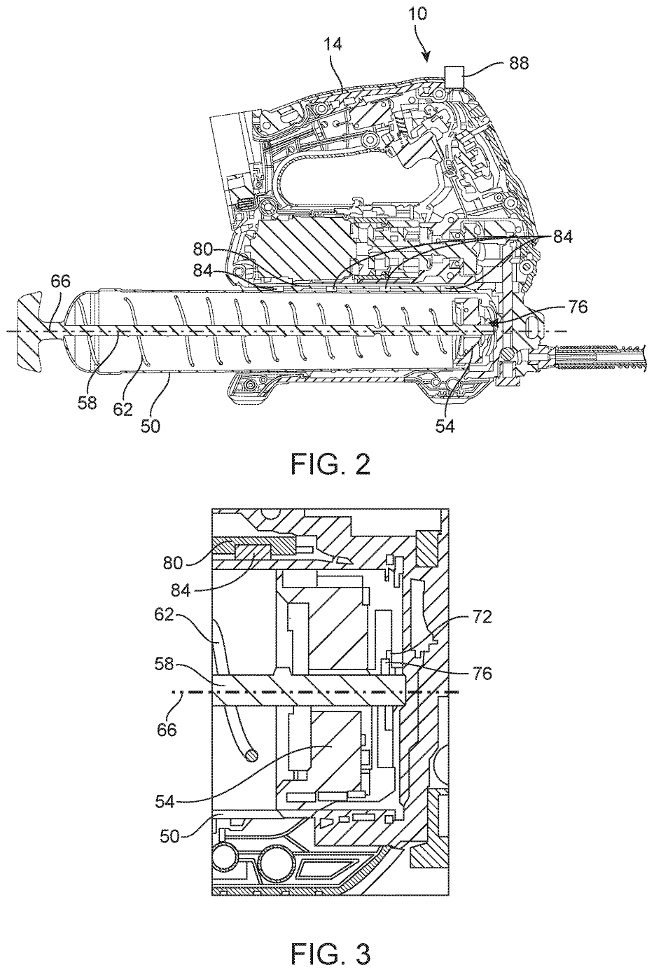

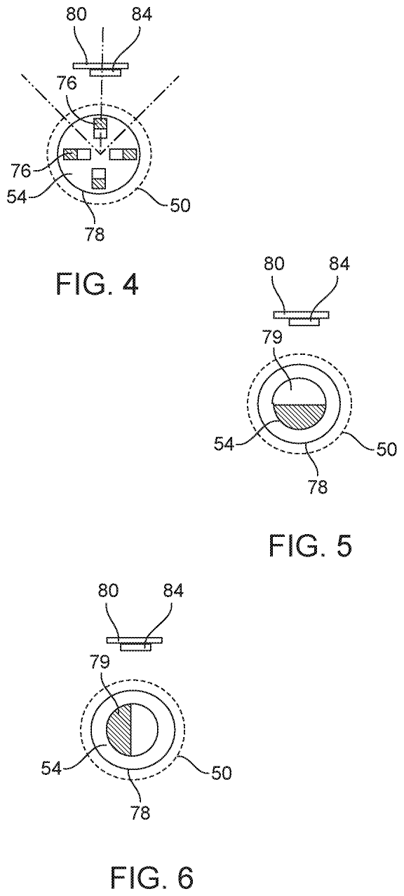

With reference to FIGS. 2 and 3, the piston 54 is coupled to the rod 58 by a washer 72 that holds a magnet 76 on the rod 58 between the piston 54 and the washer 72. In other embodiments, the magnet 76 may be coupled directly to the piston 54, or maintained on the rod 58 in another manner. With reference to FIG. 4, in one embodiment, more than one magnet 76 (e.g., four magnets, as shown) is coupled to the piston 54 adjacent the outer circumference 78 of the canister 50. The magnets are positioned radially equidistantly about the piston 54 and oriented with one of the poles (e.g., the north pole) positioned facing radially inward toward the center of the piston 54 and the other pole (e.g., the south pole) facing radially outward such that the same pole of each of the magnets 76 is oriented in the same direction on the piston 54. In other embodiments, the orientation of the magnets 76 may be reversed.

Returning to FIGS. 2 and 3, the housing 14 of the grease gun 10 supports a sensor board 80 (i.e., a printed circuit board) adjacent (e.g., above) the canister 50 and extending through the housing 14 in an orientation parallel to the canister axis 66 (the longitudinal axis of the canister 50). The sensor board 80 includes one or more sensors 84 mounted in a spaced arrangement along the sensor board 80. The sensors 84 are configured to monitor the position of the magnet 76 as the magnet 76 travels with the piston 54 and rod 58 through the canister 50. By tracking the position of the magnet 76, the sensors 84 measure the quantity (i.e., volume) of grease remaining in the interior 70 of the canister 50. The sensors 84 may be equally spaced (i.e., with equal distance between each sensor 84) along the length of the sensor board 80 or may instead be positioned in locations corresponding to different grease volume levels (e.g., 10% of the maximum volume of grease remaining, 20% remaining, 25% remaining, 50% remaining, etc.). In other embodiments, the grease gun 10 may include more than one sensor board, with each sensor board including one or more sensors 84, and the sensors 84 are positioned to correspond to different grease volume levels. While the sensors 84 in the present embodiment are configured as Hall-effect sensors that detect the position of the magnet 76 relative to the sensors 84, the sensors may instead be configured as any type of non-contact sensor, including an inductive sensor, or other magnetic-type sensor (e.g., a TMR sensor, etc.).

With reference to FIGS. 4-6, in an embodiment including more than one magnet 76 coupled to the piston 54, it will be appreciated that the magnets 76 may be more closely positioned in relation to the sensor 84 in comparison to embodiments including only one magnet coupled adjacent the center of the piston 54. The resulting arrangement accounts for rotational freedom of the piston 54 and results in a stronger magnetic field sensed by the sensor 84. It will also be appreciated that in an embodiment including more than one magnet 76, a pole of one of the magnets will be positioned within an angular range relative to the sensor 84. In embodiments with more than one magnet spaced radially equidistantly about the piston 54, the maximum angular range is between −90° and 90° (e.g., in an embodiment with two magnets spaced 180° apart on the piston 54) and for embodiments including more than two magnets, the angular range is further reduced. In the embodiment of FIG. 4, one magnet will be positioned within a range between −45° and 45° of the sensor 84. It will be further appreciated that the combined magnetic field produced by the magnets 76 is more accurately and consistently sensed by the sensors 84 coupled to the sensor board 80. FIGS. 5 and 6 illustrate the magnetic field 79 produced by the magnets 76 at different rotational positions of the piston 54, with the poles (e.g., the north pole) oriented within a range between −90° and 90° (0° shown in FIG. 5, 90° shown in FIG. 6).

The sensors 84 output signals indicating the position of the magnet 76 and, thereby, the piston 54, correlating to the volume of grease remaining in the canister 50. As the spring 62 applies a force to the piston 54 to translate the piston 54 and discharge grease from the canister 50, the signals generated by the sensors 84 change as the magnet 76 moves with the piston 54 relative to each of the sensors 84. The signals from the respective sensors 84 are received by the sensor board 80 and converted to a grease percentage. The grease gun 10 may alert a user of the quantity of grease remaining in the canister 50 in response to detecting a position of the piston 54 by the sensor 84. For instance, the grease gun 10 may alert a user when the percentage of grease left in the canister 50 has reached 10% of the maximum volume of grease remaining. The percentage of remaining grease may instead by another percentage of the maximum volume. The grease gun 10 may provide an indication (e.g., a visual indication from an indicator 88 on the housing 14) to the user that the volume of grease in the canister 50 has been nearly expended and the canister 50 will need to be refilled. For example, the grease gun 10 may illuminate an LED or an icon on a display screen to indicate the canister 50 is low. Additionally or alternatively, the grease gun 10 may include a speaker that emits an audible tone or noise to indicate the canister 50 is low. In some embodiments, the grease gun 10 may include a display that indicates an amount of grease remaining in the canister 50. The display may constantly display the amount of grease in the canister 50 during operation of the grease gun 10, not only when the canister 50 is low. For example, the amount of grease remaining in the canister 50 may be displayed as a numerical percentage, as a series of LEDs, or as fill level gauge. The grease gun 10 may perform other operations separate from or in addition to notifying the user of the remaining volume of grease.

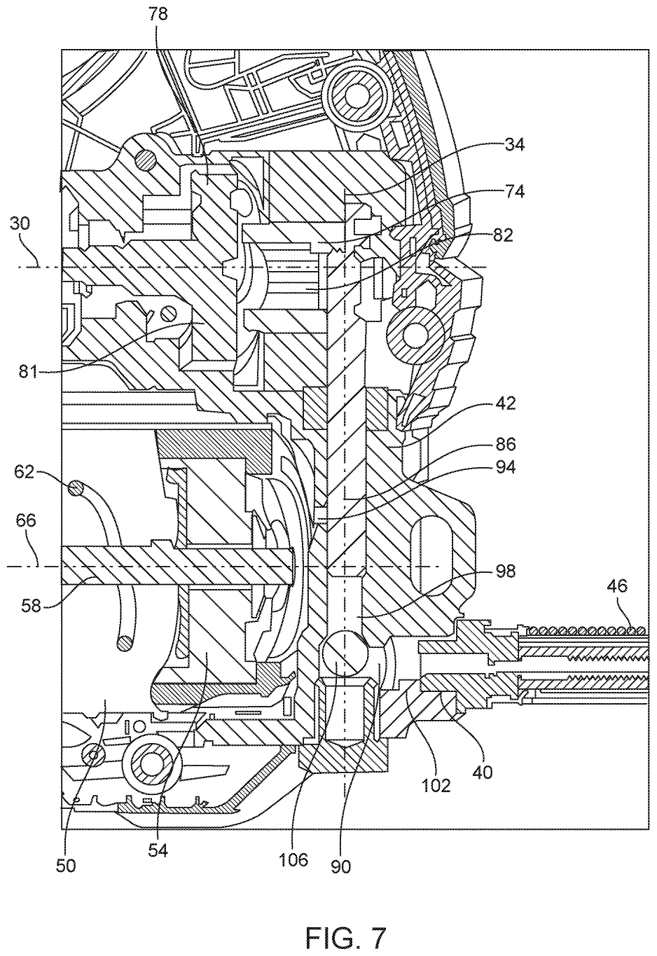

With reference to FIG. 7, the illustrated pump assembly 26 includes a yoke 74 coupled with the output 81 of the gear assembly 22. The yoke 74 includes a slot 82 that receives a lobe (not shown) of the output 81 that is offset from the rotation axis 30. The lobe is movable within the slot 82. Rotation about the rotation axis 30 of the output 81 and lobe from the top dead center to the bottom dead center positions of rotation causes reciprocation of the yoke 74, which is constrained to reciprocate in a vertical (as shown in FIG. 7) direction, between top dead center and bottom dead center positions. A plunger 86 is coupled to the yoke 74 and is supported at least partially within the pump housing 42. The plunger 86 translates between top dead center and bottom dead center positions along with the yoke 74. In other embodiments, the pump assembly 26 may have other configurations, such as a cam and follower mechanism, bevel gears, and the like, to transmit rotation of the lobe to reciprocation of the plunger 86.

With continued reference to FIG. 7, the pump housing 42 includes a discharge path 90 that communicates the interior 70 of the canister 50 with the outlet 40 to dispense grease through the hose 46. The discharge path 90 includes an inlet portion 94, a pumping portion 98 downstream of the inlet portion 94, and an outlet portion 102 downstream of the pumping portion 98. The plunger 86 reciprocates in the pumping portion 98 along the pump axis 34, which is defined by the pumping portion 98. A check valve 106 is at least partially positioned in the discharge path 90 downstream of the plunger 86, separating the pumping portion 98 and the outlet portion 102. The check valve 106 inhibits grease from flowing back into the canister 50 through the pumping portion 98 and the inlet portion 94.

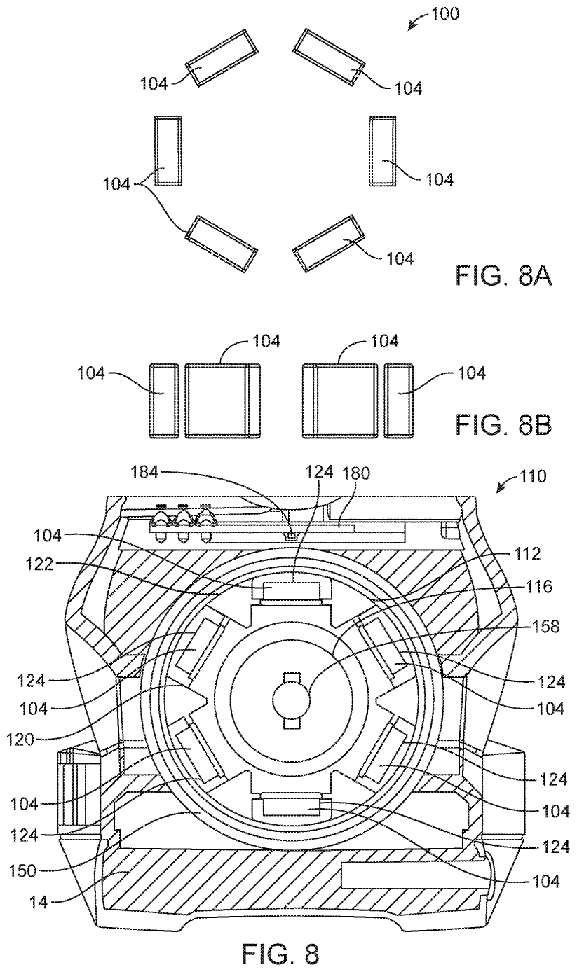

FIGS. 8, 8A, and 8B illustrate another embodiment of a grease gun 110 that is substantially similar to the grease gun 10 described above, with differences between grease gun 10 and grease gun 110 described in more detail.

The grease gun 110 includes a rod 158 to which a piston (similar to piston 54 in FIG. 7) is coupled. The piston and rod 158 are slidable in the canister 150 to urge grease in the canister 150 toward the pump assembly (similar to the pump assembly 26 in FIG. 7). A support ring 112 is coupled to the rod 158 adjacent to the piston. The support ring 112 is positioned in the canister 150 on the side of the piston 54 in which no grease is stored. In the present embodiment, the support ring 112 is not rotatably fixed to the rod 58 and is capable of rotating about the rod 58. In other embodiments, the support ring may be fixed to the rod 58.

The support ring 112 has a generally cylindrical shape including a hub portion 116 that is coupled to the rod 158. The hub portion 116 abuts the piston and the spring (similar to spring 62 in FIG. 7) abuts the hub portion 116. In that manner, the spring imparts a biasing force to the piston through the hub portion 116 of the support ring 112. A magnet support portion 120 extends radially outward from the hub portion 116. The magnet support portion 120 has an outer diameter 122 that is less than the outer diameter of the piston so that the magnet support portion does not engage the canister 150. The magnet support portion 120 has one or more recesses 124 that receive a magnet arrangement 100 configured as a sensor target of a grease level sensor 184 (e.g., a Hall effect sensor) supported on a sensor board 180 adjacent the canister 150. In other embodiments, another type of sensor and sensor target may be used (e.g., a conductive metal and an inductive sensor). It should be understood that the shape of the recess 124 corresponds to the shape of the magnet positioned in the recess.

As shown in FIGS. 8A and 8B, the magnet arrangement 100 includes six magnets 104. The magnets 104 are equally spaced apart from each other about a shared central axis (e.g., an axis similar to the canister axis 66 shown in FIG. 7, or another axis substantially coaxial with the canister axis 66). Similar to the magnets 76, the magnet arrangement 100 is configured to produce magnetic fields that are sensed or detected by the sensors 184 on the sensor board 180.

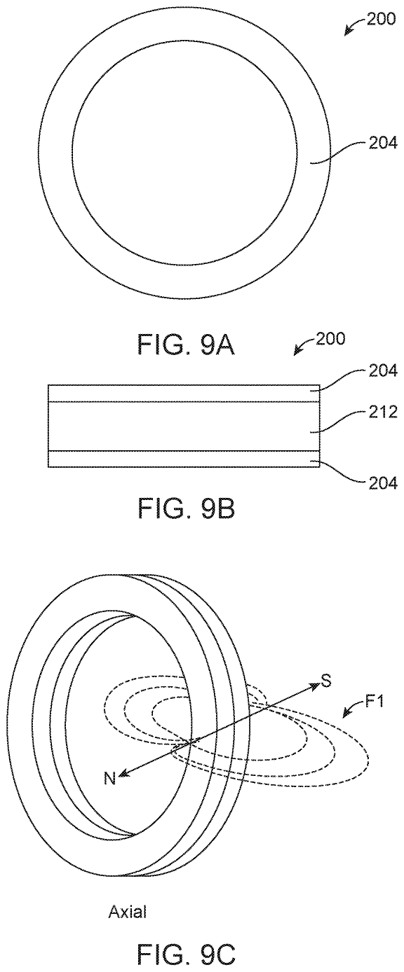

FIGS. 9A-9C, 10A-10C, and 11A-11B illustrate other magnet arrangements 200, 300, 400 for use with the grease gun 110. Similar to the magnets 76, the magnet arrangements 200, 300, 400 are configured to produce magnetic fields that are sensed or detected by the sensors 184 on the sensor board 180.

As shown in FIG. 9A-9C, the magnet arrangement 200 includes two magnets 204. Each magnet 204 is an annular ring. The magnets 204 are supported on a support ring 212 (e.g., on opposite sides of the support ring 212) that is supported on the piston 54. The magnets 204 are arranged to form poles that produce an axial magnetic field F1 as shown in FIG. 9C. The axial magnetic field F1 is arranged parallel to the canister axis 66 (shown in FIG. 7)

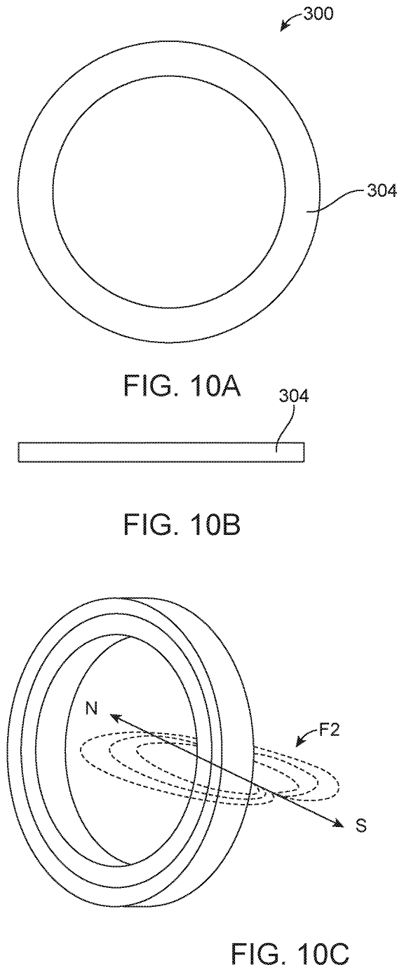

As shown in FIGS. 10A-10C, the magnet arrangement 300 includes one magnet 304. The magnet 304 is an annular ring. The magnet 304 is supported on the piston 54. The magnet 304 produces a radial magnet field F2 that is arranged perpendicular to the canister axis (shown in FIG. 7).

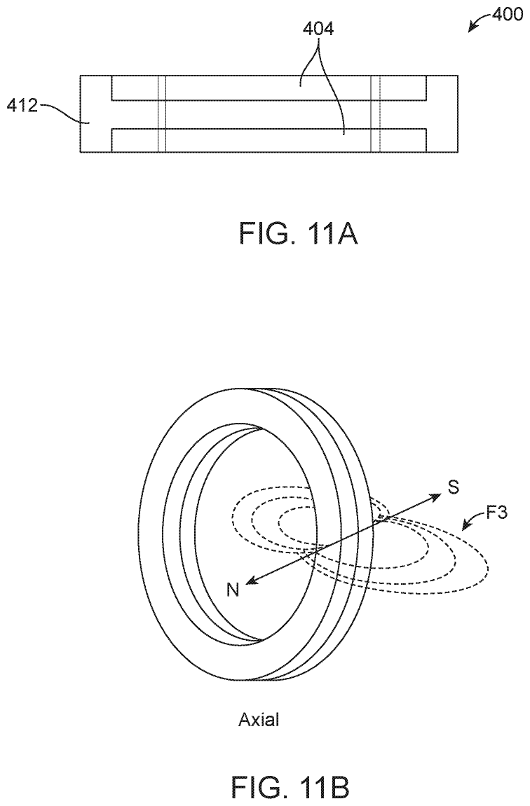

As shown in FIGS. 11A-11B, the magnet arrangement 400 includes two magnets 404. Each magnet 404 is an annular ring. The magnets 404 are supported on a support ring 412 that is supported on the piston 54. The magnets 404 produce an axial magnetic field F3 that is arranged parallel to the canister axis 66 (shown in FIG. 7).

As noted above, the sensors 84, 184 on the sensor boards 80, 180 may be a Hall effect sensor. In some embodiments, the Hall effect sensor may be a 3-axis Hall effect sensor. Such a Hall effect sensor measures magnetic field strength from the magnet arrangements 100, 200, 300, 400 in multiple (e.g., three) directions.

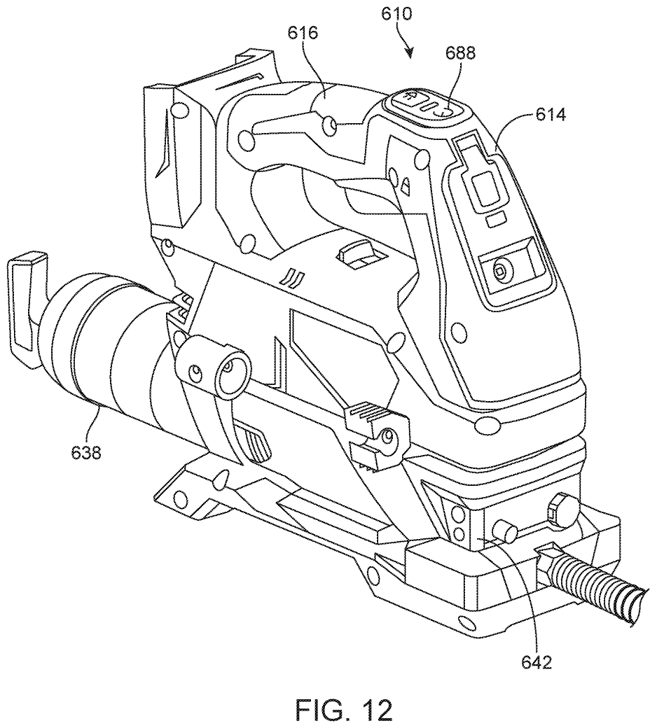

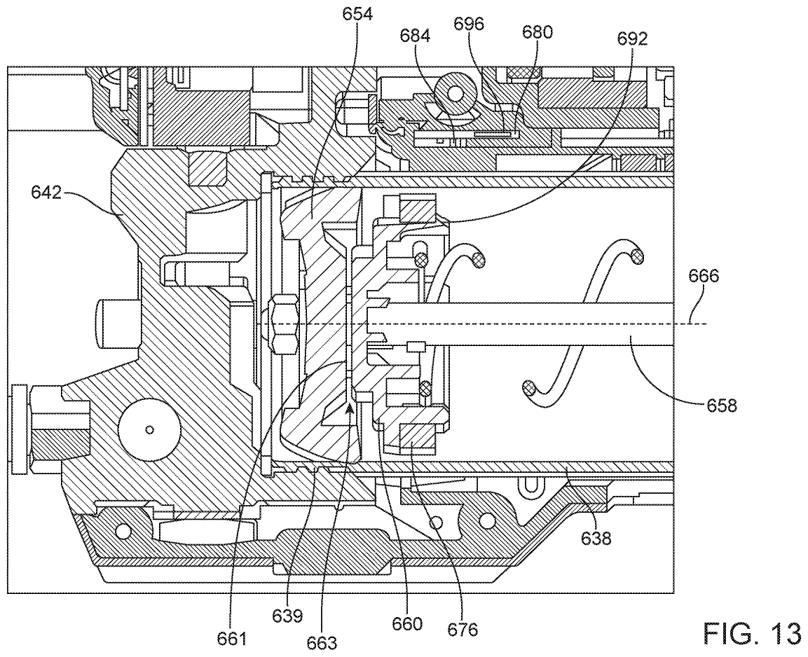

FIGS. 12 and 13 illustrate another embodiment of a grease gun 610. The grease gun 610 is substantially similar to the previously described grease guns 10, 110, with only differences between the grease guns 10, 110, 610 described below.

The grease gun 610 includes an indicator 688 coupled to the housing 614. In the illustrated embodiment, the indicator 688 is adjacent the front of the handle 616. The indicator 688 provides a visual indication of one or more conditions of the grease gun (e.g., remaining grease amount in the canister, run-time, battery charge, pressure at the outlet to the hose, etc.).

With continued reference to FIG. 13, the grease gun 610 includes a sensor board 680 positioned adjacent to and external to the canister assembly 638 and within the housing 614. A sensor 684 is coupled to the sensor board 680 on a side facing the canister assembly 638. The sensor board 680 is positioned in the housing 614 closer to the end 639 of the canister assembly 638 that is coupled to the pump housing 642. A piston 654 (e.g., a rubber piston) is coupled to the rod 658. The piston 654 and rod 658 travel along the canister axis 666 within the canister assembly 638. A shuttle, or magnet holder 660, is also coupled to the rod 658 adjacent a rear face 661 of the piston 654. A gap 663 is defined between the piston 654 and the magnet holder 660, permitting deflection of the piston 654 without the piston 654 contacting the magnet holder 660. The magnet holder 660 travels with the rod 658 through the canister assembly 638. A magnet 676 is coupled to the magnet holder 660 and translates along the canister axis 666 with the piston 654, piston 654, and magnet holder 660. In the illustrated embodiment, the magnet 676 is formed as a ring magnet. In other embodiments, the magnet may be formed in another shape as disclosed above, or in another shape. The magnet 676 is retained on the magnet holder 660 by tabs 692. The tabs 692 are deformable to allow the magnet 676 to be pressed onto the magnet holder 660.

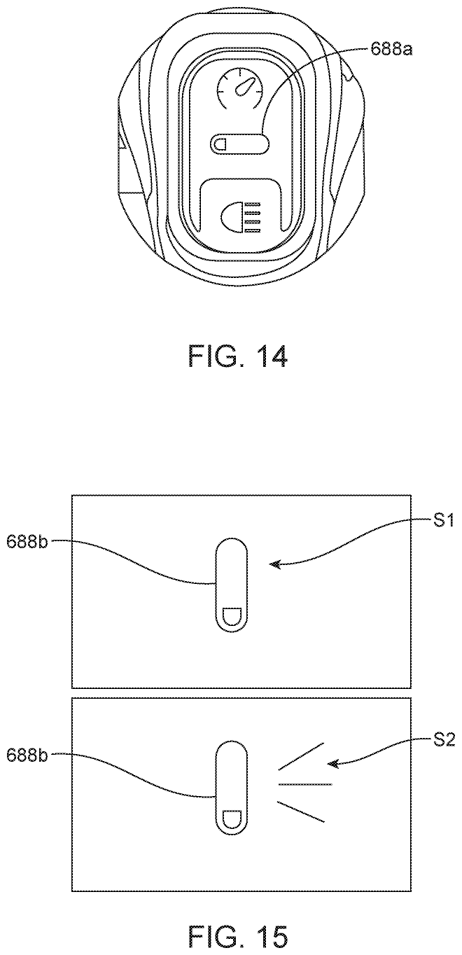

FIGS. 14 and 15 illustrate embodiments of the indicator 688a, 688b that are configured to be illuminated to indicate the grease level in the canister assembly 638. With reference to FIGS. 13-15, an electronic control unit 696 (e.g., a controller disposed on the sensor board 680) is electrically coupled to the indicator 688a, 688b. In other embodiments, the electronic control unit may be disposed elsewhere in the grease gun 610. The electronic control unit 696 receives a signal from the sensor 684 that indicates the level of grease (e.g., the volume of grease) in the canister assembly 638. The signal from the sensor 684 changes depending on the distance between the sensor 684 and the magnet 676. Based on the signal received from the sensor 684, the electronic control unit 696 illuminates the indicator 688a, 688b or controls the indicator 688a, 688b in another manner as described below. When the electronic control unit 696 receives the signal, the electronic control unit 696 compares the signal to first and second thresholds. When the signal is above a first threshold (e.g., a first voltage threshold), the electronic control unit 696 illuminates the indicator 688a, 688b in a first illuminated state. When the signal received by the electronic control unit 696 is above a second threshold (e.g., a second voltage threshold), the electronic control unit 696 illuminates the indicator 688a, 688b in a second illuminated state.

In the first embodiment of the indicator 688a, shown in FIG. 14, the indicator 688a can be changed between different colors to indicate different grease levels in the canister assembly 638. For instance, the indicator 688a may be illuminated in a first color (e.g., orange) corresponding to a first illuminated state to indicate a low level of grease in the canister assembly 638 (e.g., 10% of the grease in the canister assembly 638 remaining). The indicator 688a may then be illuminated in a second color (e.g., red) corresponding to a second illuminated state to indicate that the entire quantity of grease in the canister assembly 638 has been expended.

In the second embodiment of the indicator 688b, shown in FIG. 15, the indicator 688b can be changed between different illuminated states to indicate different grease levels in the canister assembly 638. For instance, the indicator 688b may be illuminated in a first, solidly illuminated state S1 corresponding to indicate a low level of grease in the canister assembly 638 (e.g., 10% of the grease in the canister assembly 638 remaining). The indicator 688b may then be illuminated in a second, flashing state S2 to indicate that the entire quantity of grease in the canister assembly 638 has been expended.

In other embodiments, combinations of different colors and different illumination states may be used to indicate the level of grease remaining in the canister. Table 1 below includes a list of combinations of different colors and illumination states.

TABLE 1
Notification Type, Color and Illumination State of Indicator

| | Indicator | Indicator | |
|---|---|---|---|
| Notification | Color | Status | Strategy |
| Low Grease | Orange | Flashing | 1 LED, 1 Icon, 1 Color |
| | | Solid | 1 LED, 1 Icon, 2 Color |
| | Red | Flashing | 2 LED, 1 Icon, 2 Color |
| Empty | Orange | Solid | 2 LED, 2 Icon, 2 Color |
| Grease | Red | Flashing | |
| | | Solid | |

As shown in Table 1, the indicator may include any of the combinations (“Strategies”) of the number of LEDs, the number of Icons, and the number of colors listed in Table 1.

Table 2 below shows different combinations of the LED color and indicator status based on the Strategies listed in Table 1. The combinations shown in Table 2 should be considered exemplary combinations. Other unlisted combinations are possible.

TABLE 2
Exemplary Indicator Combinations

| Combination | | Indicator | |
|---|---|---|---|
| No. | Notification | Color | Indicator Status |
| 1 | Low Grease | Orange | Flashing |
| | Empty Grease | Orange | Solid |
| 2 | Low Grease | Orange | Flashing |
| | Empty Grease | Red | Solid |
| 3 | Low Grease | Orange | Flashing |
| | Empty Grease | Red | Flashing |
| 4 | Low Grease | Red | Flashing |
| | Empty Grease | Red | Solid |

In a first combination, when the grease is at a low level (e.g., 10% remaining), the indicator is an orange color in a flashing state and when the grease has been emptied, the indicator is an orange color and in a solid state. In a second combination, when the grease is at a low level (e.g., 10% remaining), the indicator is an orange color in a flashing state and when the grease has been emptied, the indicator is red color and in a solid state. In a third combination, when the grease is at a low level (e.g., 10% remaining), the indicator is an orange color in a flashing state and when the grease has been emptied, the indicator is a red color and in a flashing state. In a fourth combination, when the grease is at a low level (e.g., 10% remaining), the indicator is a red color in a flashing state and when the grease has been emptied, the indicator is a red color and in a solid state.

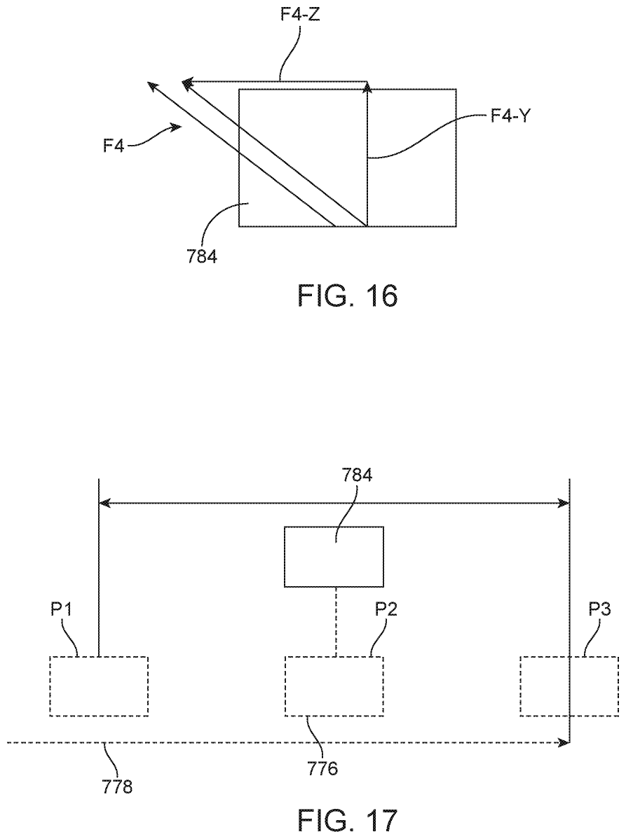

FIGS. 16-18 illustrate an exemplary sensor, the travel of a sensor target relative to the sensor, and graph illustrating the sensor outputs (e.g., the voltage outputs) of the sensor based on the position of the sensor target relative to the sensor.

FIG. 16 illustrates a sensor 784 configured to be used with any of the previously described grease guns. The illustrated sensor 784 is a 3-axis Hall effect sensor that measures the magnetic field F4 of a magnet (such as one of the magnets described above) within the vicinity of the sensor 784. The sensor 784 measures each of the X-axis component (directed out of the page), Y-axis component F4-Y, and Z-axis components F4-Z of the magnetic field F4. The sensor 784 outputs a signal to the electronic control unit that is indicative of the strength of the magnetic field F4. The strength of the magnetic field F4 is in turn indicative of the position of the magnet 776 (FIG. 17) relative to the sensor 784.

FIG. 17 illustrates the travel of the magnet 776 relative to the sensor 784. As the magnet 776 travels along a travel axis 778, the magnet 776 enters a sensitivity zone in which a magnetic field (F4, FIG. 16) of the magnet 776 is strong enough that sensor 784 is able to detect the magnetic field F4. The first position P1 of the magnet 776 corresponds to a beginning of the sensitivity zone. As the magnet 776 continues to travel along the travel axis 778, the magnet reaches a second position P2. The second position P2 corresponds to a level of grease in the canister of the grease gun that considered to be a low level of grease (e.g., 10%) characterized as nearly depleted. In the illustrated embodiment, the second position P2 is a position at which the magnet 776 is at its closest proximity to (e.g., directly beneath) the sensor 784. The magnet 776 continues to travel along the travel axis 778 until the magnet 776 reaches its travel limit at position P3, corresponding to the grease having been expended from the canister.

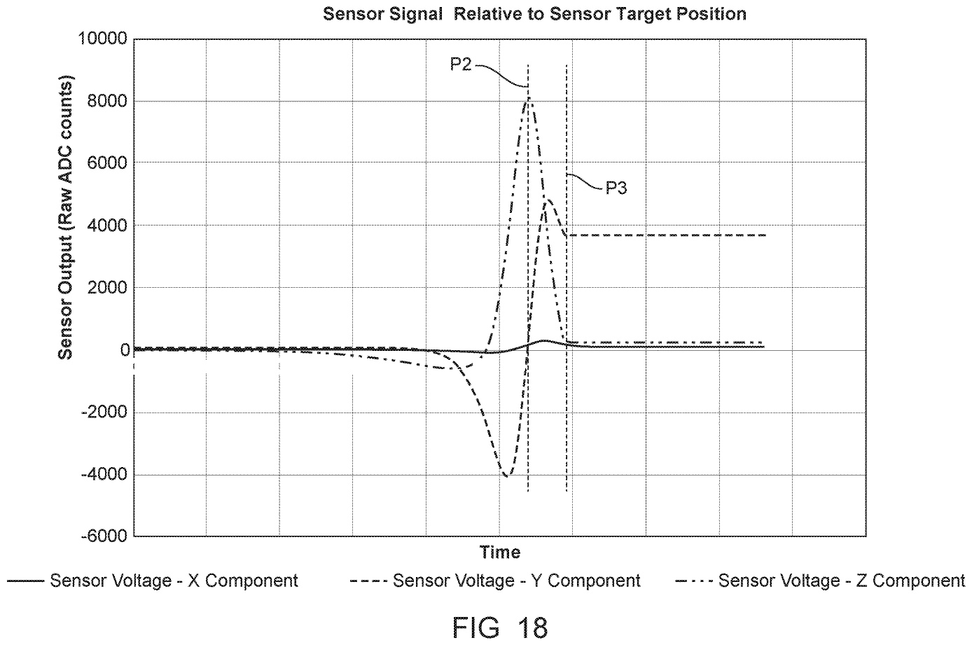

FIG. 18 illustrates the X-, Y-, and Z-axis components of the signal that that sensor 784 outputs as the magnet 776 travels relative to the sensor 784. As the magnet 776 travels along the travel axis 778 (corresponding to the x-axis of the graph), the sensor 784 outputs the exemplary voltages. The electronic control unit (e.g., electronic control unit 696) receives the X-, Y-, and Z-axis components of the signal. In other embodiments, the output may be another unit other than voltage. The electronic control unit compares one or more of the components of the signal to the one or more respective thresholds and determines when the magnet 776 has reached the position P2 corresponding to a low level grease and the position P3 corresponding to an emptied canister . . . . In the illustrated embodiment, the electronic control unit may compare the Z-axis component to a maximum voltage value corresponding to the peak of the Z-axis component curve. The peak of the Z-axis component curve may indicate that the magnet 776 has reached the second position P2, corresponding to a low level of grease. Alternatively, the electronic control unit may compare the Y-component of the signal to a threshold and determine when the Y-component of the signal changes from a negative value to a positive value, corresponding to the magnet 776 reaching the second position P2 corresponding to a low level of grease. In the illustrated embodiment, the electronic control unit may identify when the Y-axis component reaches a steady, non-zero state after fluctuating. The steady, non-zero state of the Y-axis component may indicate that the magnet 776 has reached the third position P3, corresponding to an emptied canister. In another embodiment, the electronic control unit may compare two components of the signal to respective first and second thresholds and determine a position of the magnet 776 when both of the thresholds are reached.

In another embodiment, the electronic control unit may determine whether one or more components of the signal from the sensor 784 is changing or is at a steady state (e.g., no longer changing). In another embodiment in which the sensor is a single-axis sensor, electronic control unit may compare the signal to two different thresholds. For instance, the first threshold would correspond to a low level of grease and the second threshold would correspond to an empty canister. In still other embodiments, the electronic control unit may determine when a maximum value has been reached and then determine when a component of the signal has fallen below the threshold.

Although the subject matter has been described in detail with reference to certain preferred embodiments, variations and modifications exist within the scope and spirit of one or more independent aspects of the subject matter as described. Various features of the subject matter are set forth in the following claims.

What is claimed is:

1. A grease gun configured to dispense grease, the grease gun comprising:
a housing;
a motor assembly supported in the housing;
a pump assembly driven by the motor assembly to generate a flow of grease, the pump assembly including a plunger;
a canister assembly configured to provide grease to the pump assembly, the canister assembly including a canister defining an interior in which grease is stored and a piston that is translatable within the canister along a canister axis;
a pump housing supported by the housing and to which the canister assembly is coupled, the pump housing defining a discharge path in which the plunger is at least partially supported, the discharge path communicating the interior of the canister with an outlet of the discharge path; and
a sensor configured to monitor a position of the piston and output a signal indicative of the position of the piston.

2. The grease gun of claim 1, wherein the sensor is a Hall-effect sensor, and wherein the grease gun further comprises a magnet coupled to the piston for movement therewith.

3. The grease gun of claim 2, wherein the magnet is one of a plurality of magnets coupled to the piston.

4. The grease gun of claim 3, wherein the plurality of magnets includes four magnets.

5. The grease gun of claim 1, further comprising a printed circuit board supported by the housing adjacent the canister and upon which the sensor is mounted, wherein the printed circuit board is oriented parallel with a longitudinal axis of the canister.

6. The grease gun of claim 5, wherein the sensor is a first sensor of a plurality of sensors mounted to the printed circuit board.

7. The grease gun of claim 6, wherein the plurality of sensors is equally spaced along a length of the printed circuit board.

8. The grease gun of claim 5, wherein the sensor is a first sensor of a plurality of sensors, the printed circuit board is a first printed circuit board of a plurality of printed circuit boards, each circuit board having at least one sensor mounted thereto.

9. The grease gun of claim 1, further comprising an indicator on the housing, wherein the indicator is configured to alert a user of the grease gun of a remaining quantity of grease in the canister in response to the sensor detecting the position of the piston.

10. A grease gun configured to dispense grease, the grease gun comprising:
a housing;
a motor assembly supported in the housing;
a pump assembly driven by the motor assembly to generate a flow of grease, the pump assembly including a plunger;
a canister assembly configured to provide grease to the pump assembly, the canister assembly including a canister defining an interior in which grease is stored and a piston that is translatable within the canister along a canister axis;
a pump housing supported by the housing and to which the canister assembly is coupled, the pump housing defining a discharge path in which the plunger is at least partially supported, the discharge path communicating the interior of the canister with an outlet of the discharge path;
a sensor target coupled to and movable with the piston; and
a sensor configured to monitor a position of the sensor target and output a signal indicative of the position of the sensor target and the piston.

11. The grease gun of claim 10, wherein the sensor target is coupled to a shuttle that is coupled to the piston.

12. The grease gun of claim 10, wherein the sensor target is a magnet and the sensor is a Hall effect sensor.

13. The grease gun of claim 10, further comprising an electronic control unit configured to receive the signal and activate an indicator based on the position indicated by the sensor.

14. The grease gun of claim 13, wherein the electronic control unit compares the signal to a first threshold and a second threshold.

15. The grease gun of claim 14, wherein the first threshold corresponds to a level of grease that is greater than the level of grease corresponding to the second signal.

16. The grease gun of claim 15, wherein when the signal is above the second threshold, the signal indicates that a volume of grease in the canister has been expended.

17. The grease gun of claim 14, wherein the indicator is activated in a first state related to a first position of the sensor target and in a second state related to a second position of the sensor target.

18. The grease gun of claim 17, wherein the first state is a first color and the second state is a second color.

19. The grease gun of claim 17, wherein the first state is a solidly-illuminated state and the second state is a flashing state.

20. A grease gun configured to dispense grease, the grease gun comprising:
a housing;
a motor assembly supported in the housing;
a pump assembly driven by the motor assembly to generate a flow of grease, the pump assembly including a plunger;
a canister assembly configured to provide grease to the pump assembly, the canister assembly including a canister defining an interior in which grease is stored and a piston that is translatable within the canister along a canister axis;
a pump housing supported by the housing and to which the canister assembly is coupled, the pump housing defining a discharge path in which the plunger is at least partially supported, the discharge path communicating the interior of the canister with an outlet of the discharge path;
a magnet having a ring shape coupled to a shuttle that is coupled to and movable with the piston; and
a Hall effect sensor configured to monitor a position of the magnet and output a signal indicative of the position of the magnet and the piston.
